(19) United States
(12) Patent Application Publication
(10) Pub. No.: US 2024/0275151 A1
(43) Pub. Date: Aug. 15, 2024

(54) ELECTRICAL SOCKET MAGPLATE

(71) Applicants: Frank Felix, Doylestown, OH (US); Adam Costello, Warren, OH (US)

(72) Inventors: Frank Felix, Doylestown, OH (US); Adam Costello, Warren, OH (US)

(21) Appl. No.: 18/307,630

(22) Filed: Apr. 26, 2023

Related U.S. Application Data
(60) Provisional application No. 63/444,362, filed on Feb. 9, 2023.

(51) Int. Cl. H02G 3/14

(52) U.S. Cl. CPC H02G 3/14

(57) ABSTRACT

Provided is an electrical outlet screwless covering which may include a magnetically attachable faceplate and an intermediary plate with fasteners. The entire covering may be attachable without use of screws, contain no screw-holes, and be selectively removable from the electrical outlet.

### I. BACKGROUND

### A. Cross Reference to Related Applications

This application claims the benefit of U.S. Provisional Application No. 63/444,362, filed Feb. 9, 2023, the entirety of which is fully incorporated by reference herein.

### B. Field of the Invention

The present subject matter is directed to apparatuses and methods for covering electrical outlet openings. More specifically, the present subject matter is directed to apparatuses and methods for specialized outlet plates that can be attached without screws.

### C. Description of Related Art

Contractors and homeowners manage electrical system construction and installation regularly. A concern amongst these groups is the outlets for electrical plugs and light switches. The current practice involves a receptacle within a house wall, within which is installed an electrical junction box having screw holes. A plate, fitting over the plugs or light switches, is then affixed to the junction box using screws. This plate covers the receptacle to protect the junction box from tampering and covering the unsightly appearance of the junction box, itself.

There are issues with this system, however. Attaching the plate using screws takes time, and the screws used to attach the plate to the junction box are small and can be easily dropped or lost. The existing plate is then useless until the screws are replaced, which replacement can cost money and more time. Additionally, leaving an individual screw hole empty can look unprofessional or careless. Even the screws, themselves-visible from the front of the plate—may look aesthetically displeasing.

This product attempts to solve this problem by providing an improved electric outlet plate, configured for electrical outlets, light switches, and other similar structures. The plate secures to an outlet junction box without the need for screws. Additionally, without such screws and the attendant screw holes, the front of the plate can have a completely flat, sleek, and clean look. The installation time for these screwless plates is also greatly reduced, and there is no risk of losing small, difficult-to-find screws.

Overall, the invention described allows contractors and homeowners to install plate coverings to electrical outlets, light switches, and other similar structures easily, quickly, and in a manner that is more aesthetically pleasing, in furtherance of the activities described above.

### II. Summary

In accordance with one aspect of the present disclosure, a screwless covering for electrical outlets, comprising a fastening system, wherein the system includes a faceplate having a cover layer, with a front side and a back side, and a back layer. The back layer is a magnetic strip affixed to the back side of the cover layer. The whole system aligns with an electrical outlet junction box and an electrical outlet receptacle, and the system affixes to the junction box such that it covers the receptacle.

In accordance with another aspect of the present disclosure, the cover layer front side may additionally includes graphical indicia, such as graphic designs. The faceplate may be removable. The magnetic strip may cover the entire area of the cover layer back side, at least a portion of the entire area of the cover layer back side, or a perimeter of the cover layer back side and may include Neodymium magnets or rubberized magnets, or in the alternative the back layer may include a plurality of magnets disposed along the edges of the cover layer back side. The magnetic strip on the back layer of the faceplate may possess a magnetic strength sufficient to secure the faceplate to the electrical outlet junction box and the electrical outlet receptacle and to allow for removal of the faceplate from the electrical outlet junction box and electrical outlet receptacle by a pulling action.

In accordance with another aspect of the present disclosure, a covering as described above wherein the fastening system further includes an intermediary plate having a front side and a back side. The intermediary plate secures to the junction box using at least one fastener, and the fasteners are configured to insert into screw holes in the junction box. The faceplate back layer affixes to the intermediary plate front side.

In accordance with another aspect of the present disclosure, the intermediary plate is metal, and the fasteners are push-screws. The intermediary plate and faceplate may be configured to fit a light switch, a plug outlet comprising a plurality of sockets, or a four-socket outlet. The fastening system may be selectively removable from the junction box.

In accordance with another aspect of the present disclosure, a method of covering electrical outlets is provided. The steps of the method include providing a screwless covering including a fastening system, the fastening system including a faceplate having a cover layer, with a front side and a back side, and a back layer. The back layer is a magnetic strip affixed to the back side of the cover layer. The whole system aligns with an electrical outlet junction box and an electrical outlet receptacle, and the system affixes to the junction box such that it covers the receptacle. The next step includes unscrewing plate screws attaching an old covering to the junction box, and removing the old covering. Finally, one affixes the screwless covering to the junction box, covering the receptacle.

In accordance with another aspect of the present disclosure, a method as described above further includes the steps of providing a screwless covering, further including a fastening system, wherein the fastening system includes an intermediary plate having a front side and a back side. The intermediary plate is secured to the junction box using at least one fastener, wherein the at least one fastener is configured to be inserted into screw holes in the junction box. The faceplate back layer is designed to affix to the front side of the intermediary plate. Additionally, the method also includes the steps of affixing the intermediary plate to the junction box using the fasteners and affixing the faceplate to the intermediary plate.

Still other benefits and advantages of the invention will become apparent to those skilled in the art to which it pertains upon a reading and understanding of the following detailed specification.

### III. Brief Description of the Figures

The above drawings form part of the disclosure and specification and are included to further demonstrate certain aspects of the inventive disclosure, which aspects will be described in detail later in this specification. The inventive disclosure may be better understood by reference to these drawings in conjunction with the detailed description.

FIG. 1 is a perspective view of the covering installed on both an electrical socket outlet and a light switch.

FIG. 2 is a perspective view of the plate, removed from a light switch.

FIG. 3 is an exploded view of the covering using an intermediary plate.

FIG. 4 is a perspective view of the covering, removed from an electrical socket outlet, with the intermediary plate affixed.

FIG. 5 is an exploded view of the covering using an intermediary plate, on a light switch.

### IV. Detailed Description

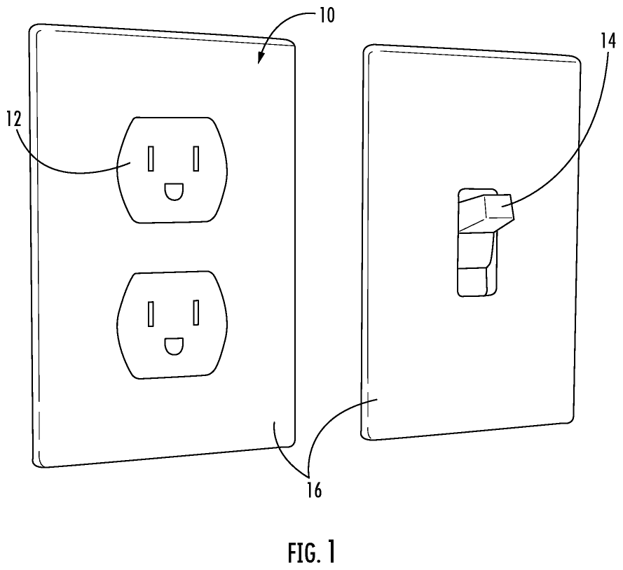

Referring now to the drawings, wherein the showings are for purposes of illustrating embodiments of the invention only and not for purposes of limiting the same, and wherein like reference numerals are understood to refer to like components, FIG. 1 shows a covering 10 for electrical sockets 12, light switches 14, and other wall-mounted electrical system ports. The covering may have magnetic properties, which can allow it to secure to the wall-mounted systems without the need for screws. The covering may include a faceplate 16 that can secure to the wall and be selectively removable. The faceplate 16, itself, may possess no screw-holes and can alternatively display a variety of designs, colors, and various indicia.

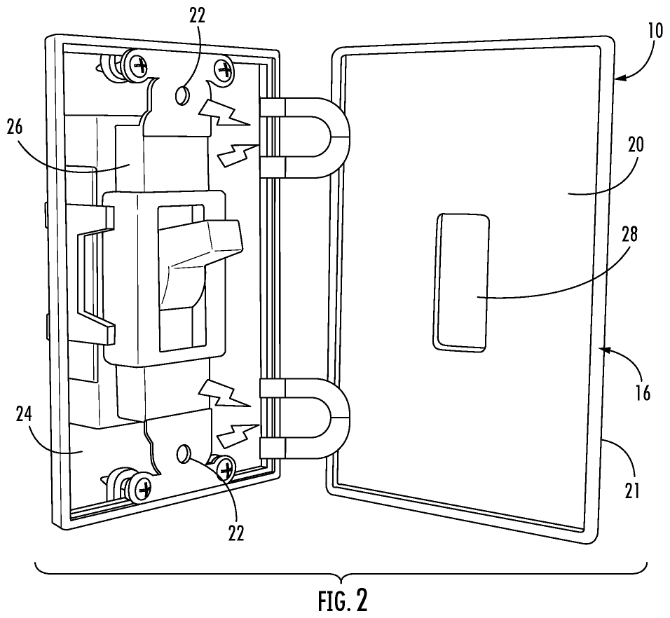

With reference now to FIG. 2, the covering may have a fastening system including a two-layer faceplate 16, with a magnetic strip 20, and cutouts 28. The faceplate cover layer 21 may face outward, toward the viewer and away from the electrical outlet, after final assembly. Additionally, the faceplate cover layer 21 may or may not contain a small slot for accommodating a screwdriver head for use in removing the faceplate 16. The back layer of the faceplate 16 may constitute a magnetic strip 20, which magnetic strip 20 can encompass the entire area of the cover layer 21 back side, at least a portion of the entire area of the cover layer 21 back side, or a perimeter of the cover layer 21 back side. In some alternative embodiments, the back layer can be a plurality of smaller magnets disposed along the cover layer 21 back side. The magnetic strip 20 may have a magnetic strength sufficient to secure the faceplate 16 to the electrical outlet junction box 26 and the electrical outlet receptacle 24 and to allow for removal of the faceplate 16 from the electrical outlet junction box 26 and electrical outlet receptacle 24 by a pulling action. The magnetic strip 20 may be Neodymium magnets, rubberized magnets, or some other magnet material chosen by a person of ordinary skill in the art having sound engineering judgment. The cutouts 28 may be cut into the faceplate 16 and sized to fit any specific wall-mounted electrical system, including but not limited to electrical socket plugs 12 and light switches 14.

With continued reference to FIG. 2, the electrical outlets include a receptacle 24, within which is housed a junction box 26. Screw-holes 22 are used to secure standard covering plates to the junction box 26. The junction box 26 may be made from a metal or a plastic or polymeric material, as described further below. Embodiments describing how a covering plate may be mounted to a non-metal junction box are provided below. The covering 10 may fit over the wall-mounted port by virtue of its particular cutout 28. The magnetic strip 20 constituting the faceplate 16 back layer can magnetically affix to the metallic junction box 26, without the need to engage with the screw-holes 22, thus covering the electrical outlet. If the junction box 26 is not made from a metal or is not metallic in nature, the fastener system may need to include additional components, as described further below.

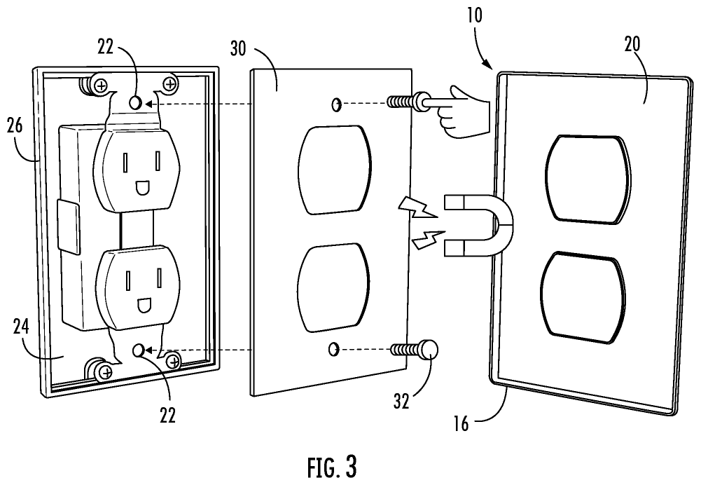

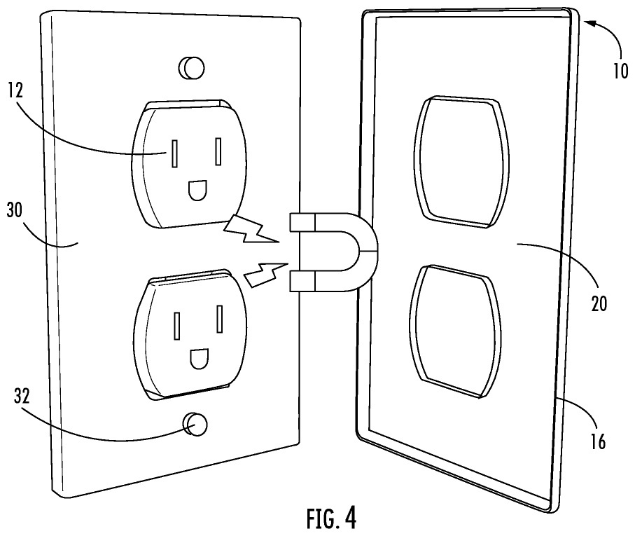

With reference to FIGS. 3-5, the covering fastening system may further include an intermediary plate 30 and fasteners 32. The intermediary plate 30 may be configured to affix to the electrical outlet junction box 26 as described in detail below. Additionally, the intermediary plate 30 may include cutouts corresponding to those in the faceplate 16, may further include holes corresponding to the fasteners 32. The intermediary plate may be made from a metal or be metallic in nature, the material utilized being chosen with sound engineering judgment of a person of ordinary skill in the art. The intermediary plate may be magnetized. The intermediary plate 30 may be sized such that the faceplate 16 is capable of being slotted over the intermediary plate 30. The fasteners 32 may be push-screws or any other type of screw or fastening mechanism and may correspond to both holes in the intermediary plate 30 and screw-holes 22 in the junction box 26.

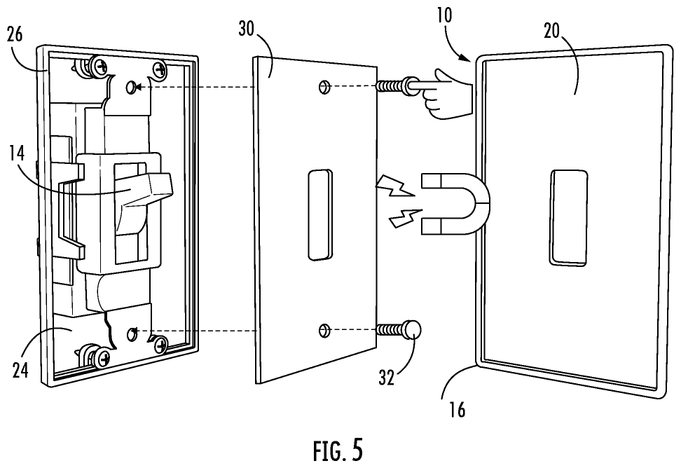

With continued reference to FIGS. 3-5, electrical outlet junction boxes 26 may be plastic or some other non-metal or non-magnetic material. In such cases, the magnetic strip 20 would be ineffective to affix the covering 10. If the junction box 26 is non-magnetic, the fastening system and method of attaching the covering 10 may need to constitute an additional step, with additional components. The first component that may need to be attached to the junction box 26 may be intermediary plate 30. The fasteners 32 (in this embodiment, push-screws 32) may be inserted into holes in the intermediary plate 30 and screw-holes 22 in the junction box 26 in the manner shown in FIGS. 3 and 5, thus securing the intermediary plate 30 to the junction box 26. The intermediary plate 30 may include a magnetic material (in this embodiment, sheet steel), which would allow the magnetic strip 20 to attach. As described above, the covering 10 may fit over the wall-mounted port by virtue of its particular cutout 28 within the faceplate 16. The magnetic strip 20 constituting the faceplate 16 back layer may magnetically affix to the junction box 26—in this case by means of the metallic intermediary plate 30 secured via the push-screws 32-without the need to engage with the junction box screw-holes 22, thus covering the electrical outlet.

Numerous embodiments have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

Having thus described the invention, it is now claimed:

I claim:

1. A screwless covering for electrical outlets, comprising:
a fastening system, wherein the fastening system comprises:
a faceplate comprising:
a cover layer having a front side and a back side; and,
a back layer, wherein the back layer is a magnetic strip affixed to the back side of the cover layer;
wherein the screwless covering is capable of aligning with an electrical outlet junction box and an electrical outlet receptacle; and
wherein the screwless covering affixes to the junction box such that it covers the receptacle.

2. The covering of claim 1, wherein the magnetic strip on the back layer of the faceplate comprises a magnetic strength sufficient to secure the faceplate to the electrical outlet junction box and the electrical outlet receptacle and to allow for removal of the faceplate from the electrical outlet junction box and electrical outlet receptacle by a pulling action.

3. The covering of claim 1, wherein the magnetic strip covers one of the entire area of the cover layer back side, at least a portion of the entire area of the cover layer back side, or a perimeter of the cover layer back side.

4. The covering of claim 3, wherein the magnetic strip comprises Neodymium magnets or rubberized magnets.

5. The covering of claim 4, wherein the back layer comprises a plurality of magnets disposed along the edges along at least a portion of a perimeter of the cover layer back side.

6. The covering of claim 1, wherein the fastening system further comprises:
an intermediary plate having a front side and a back side;
wherein the intermediary plate secures to the junction box using at least one fastener;
wherein said fasteners are configured to insert into screw holes in the junction box; and
wherein the faceplate back layer affixes to the intermediary plate front side.

7. The covering of claim 6, wherein the intermediary plate is made from a metal and the fasteners are push-screws.

8. The covering of claim 6, wherein the intermediary plate and faceplate are configured to fit a light switch.

9. The covering of claim 6, wherein the intermediary plate and faceplate are configured to fit an electrical outlet.

10. The covering of claim 9, wherein the intermediary plate and faceplate are configured to fit an outlet comprising a plurality of sockets.

11. The covering of claim 1, wherein the cover layer front side comprises graphical indicia comprising graphic designs.

12. A method of covering electrical outlets, comprising the following steps:
providing a screwless covering comprising:
a fastening system, wherein the fastening system comprises:
a faceplate;
said faceplate comprising:
a cover layer having a front side and a back side;
a back layer;
wherein the back layer is a magnetic strip affixed to the back side of the cover layer;
wherein the fastening system aligns with an electrical outlet junction box and an electrical outlet receptacle; and
wherein the fastening system affixes to the junction box such that it covers the receptacle;
unscrewing plate screws attaching an original covering to the junction box;
removing the original covering; and
affixing the screwless covering to the junction box and covering the receptacle.

13. The method of claim 12, further comprising the steps of:
providing a screwless covering further comprising:
a fastening system further comprising:
an intermediary plate having a front side and a back side;
wherein the intermediary plate secures to the junction box using at least one fastener;
wherein said fasteners are configured to insert into screw holes in the junction box; and
wherein the faceplate back layer affixes to the intermediary plate front side;
affixing the intermediary plate to the junction box using the fasteners; and
affixing the faceplate to the intermediary plate.

14. A screwless covering for electrical outlets, comprising:
a fastening system, wherein the fastening system comprises:
a faceplate having cutouts which correspond to an electrical outlet socket;
said faceplate comprising:
a cover layer having a front side and a back side;
a back layer;
wherein the back layer is a magnetic strip affixed to the back side of the cover layer;
said magnetic strip covering the entire area of the cover layer back side;
an intermediary plate having a front side and a back side;
wherein the intermediary plate is metal;
wherein the intermediary plate secures to an electrical outlet junction box using at least one fastener;
wherein said fasteners are push-screws;
said fasteners configured to insert into screw holes in the junction box;
wherein the faceplate back layer magnetically affixes to the intermediary plate front side;
wherein the system aligns with the junction box and an electrical outlet receptacle;
wherein the system affixes to the junction box such that it covers the receptacle; and
said fastening system is selectively removable from the junction box.
